(19) United States
(12) Patent Application Publication
(10) Pub. No.: US 2007/0136750 A1
(43) Pub. Date: Jun. 14, 2007

(54) Active preview for media items

(75) Inventors: Thamer A. Abanami, Seattle, WA (US); Gregory S. Cox, Kirkland, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/301,618

(22) Filed: Dec. 13, 2005

(51) Int. Cl. H04N 5/445; G06F 3/00; G06F 17/00; H04N 7/16; G06F 9/00; G06F 13/00

(52) U.S. Cl. 725/44; 725/8; 725/47; 715/838; 715/837

(57) ABSTRACT

An active preview is played while navigating media items. The active preview automatically provides a user with more information about the media item such that they may more easily determine its content before having to commit to playing it back fully or navigating deeper into the media item. The active preview may be a selected segment of the media item, a random selection from the media item, or some other media content that is associated with the media item, such as a commercial or a trailer. The active preview may be for a single media item or may be for a collection of media items. The active preview may be shown automatically or may be shown based on an event, such as an event relating to the navigation through the media items.

### BACKGROUND

Computing devices are used for a variety of purposes. Not only are computers used for business purposes they are also becoming widely used for entertainment purposes. For example, computing devices may record and display pictures, video and audio content as well as play games. Users may also watch and listen to streaming content on their computing devices that is available from a variety of content providers. The computing devices that are configured for these tasks may be traditional desktop computing devices or mobile devices. Some of these devices may be configured to store thousands of songs and videos, as well as a multitude of other media content. Accessing and remembering each of the media items can be very difficult for a user. For example, a user may become confounded when searching for a song as they are limited to searching through an exhaustive list of song names in order to find the song they are interested in playing.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An active preview is played while navigating through media items. The active preview is played automatically and provides a user with more information about the media item such that they may more easily determine its content before having to commit to playing it back fully or navigating deeper into the media item. For example, the active preview may be a selected segment of the media item, a random selection from the media item, or some other media content that is associated with the media item, such as a commercial or a trailer. The active preview may be for a single media item or may be for a collection of media items. An active preview that is for a collection of media items may display media content that is associated with one or more of the media items from the collection. The active preview may be shown automatically or may be shown based on an event, such as an event relating to the navigation through the media items. For instance, the active preview for a media item may be shown when the system focus is maintained on the media item for some predetermined idle time.

### BRIEF DESCRIPTION OF THE DRAWINGS

FIG. 1 illustrates an exemplary computing architecture for a computer;

FIG. 2 illustrates an active preview system;

FIG. 3 shows navigation and active preview of exemplary media items; and

FIG. 4 shows a process for providing an active preview for media items during navigation, in accordance with aspects of the present invention.

### DETAILED DESCRIPTION

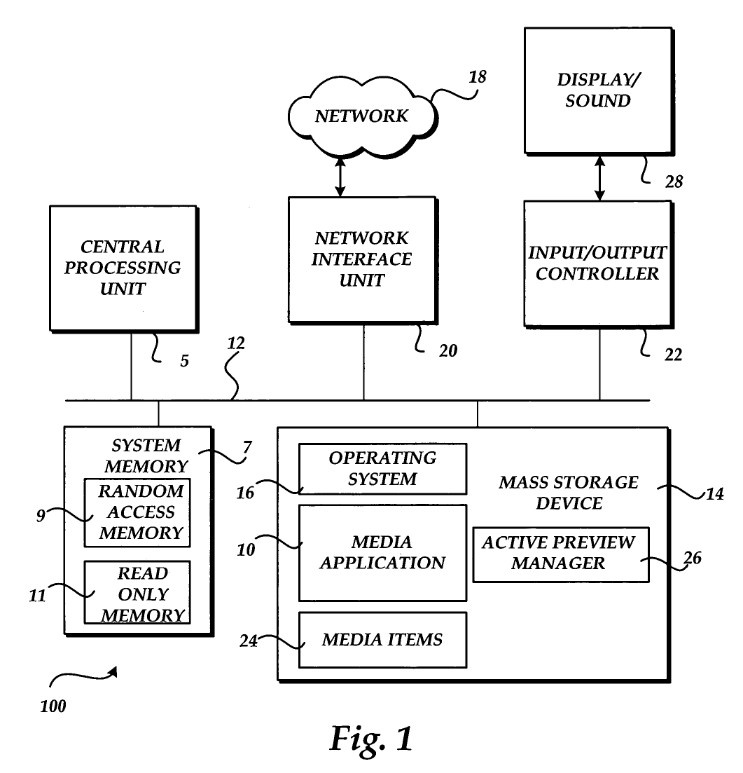

Referring now to the drawings, in which like numerals represent like elements, various aspects of the present invention will be described. In particular, FIG. 1 and the corresponding discussion are intended to provide a brief, general description of a suitable computing environment in which embodiments of the invention may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. The computer architecture shown in FIG. 1 may be configured as a mobile computing device and/or a conventional computing device. For example, computing device 100 may be configured as a smart phone, a PDA, a desktop computer, a tablet, a laptop computer, and the like. As illustrated, computer 100 includes a central processing unit 5 (“CPU”), a system memory 7, including a random access memory 9 (“RAM”) and a read-only memory (“ROM”) 11, and a system bus 12 that couples the memory to the CPU 5. A basic input/output system containing the basic routines that help to transfer information between elements within the computer, such as during startup, is stored in the ROM 11. The computer 100 further includes a mass storage device 14 for storing an operating system 16, application programs, and other program modules, which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, the computer 100 may operate in a networked environment using logical connections to remote computers through a network 18, such as the Internet. The computer 100 may connect to the network 18 through a network interface unit 20 connected to the bus 12. The network interface unit 20 may also be utilized to connect to other types of networks and remote computer systems. The connection may be a wired and/or wireless connection. The computer 100 also includes an input/output controller 22 for receiving and processing input from a number of devices, such as: a keyboard, mouse, electronic stylus and the like. Similarly, the input/output controller 22 may provide output to a display screen, speakers, or some other type of device (28).

As mentioned briefly above, a number of program modules and data files may be stored in the mass storage device 14 and RAM 9 of the computer 100, including an operating system 16 suitable for controlling the operation of a networked computing device, such as the WINDOWS MOBILE or WINDOWS XP operating systems from MICROSOFT CORPORATION of Redmond, Wash. The mass storage device 14 and RAM 9 may also store one or more program modules. In particular, the mass storage device 14 and the RAM 9 may store a media application program 10. The media application program 10 is operative to provide functionality for interacting with media items 24. For example, media application may be configured to play audio, video, browse Internet content, download media, and the like.

The media application program 10 utilizes an active preview manager 26 to assist a user in navigating media items. As will be described in greater detail below, the active preview manager 26 is configured to provide an active preview automatically for media items. For example, when a user is browsing a list of media items, active preview manager 26 is configured to automatically play a preview when the media item has the system focus for a predetermined idle time. For example, when the user is browsing video media items, and the user idles on a video, a segment of that video is previewed within a thumbnail. The thumbnail could be located on the screen in many different positions. For example, the thumbnail could be located: adjacent to the media item; above or below the media item if displayed semi-opaque; or in some predetermined area of the screen. A user may also browse a collection of media items, such as pictures. In that case, when the user idles on a collection of pictures, such as a folder containing pictures, then the preview may show a number of the pictures within a thumbnail that are included within the collection. The active preview is provided automatically and the user does not have to manually initiate playback of the media item or of the media collection to see what the item or collection contains. The previews may be automatically generated from the media item and/or they may be manually configured. For example, a user may select a segment of a song or video which they think best represents that media item to play as a preview. Additional details regarding the operation of the active preview manager 26 will be provided below.

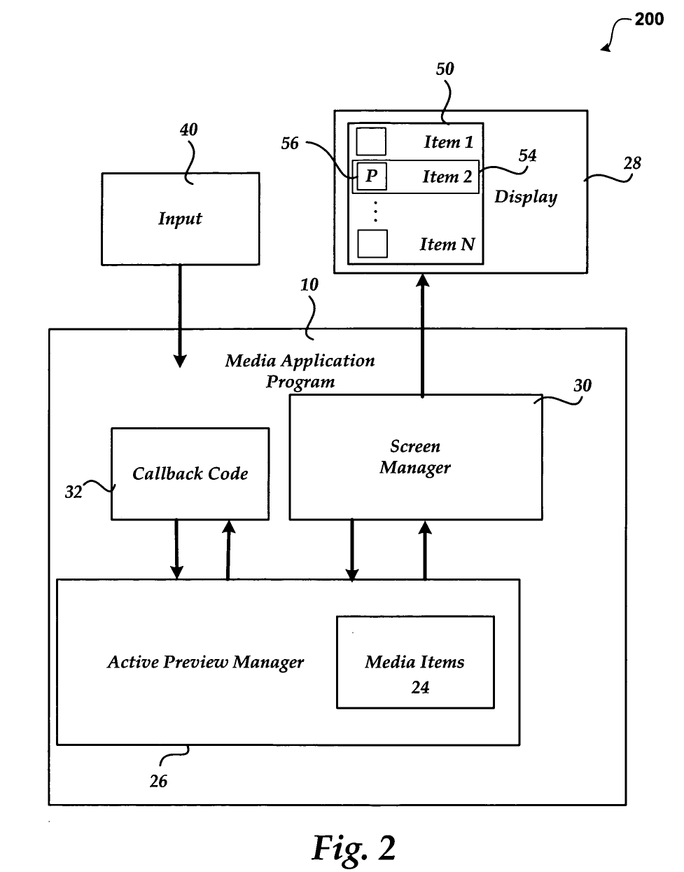

FIG. 2 illustrates an active preview system 200. As described briefly above, the active preview manager 26 monitors a user's navigation of media items and provides active previews relating to the media items based on the user's navigation. Generally, active preview manager 26 monitors the system focus and automatically plays a preview for a media item when the system focus is maintained over that media item for a predetermined idle time. According to another embodiment, previews may be displayed at the same time for each of the media items shown on display 28.

Active previewing of the media items allows a user to navigate through the media items and more easily determine the content of the media items. For example, as the user navigates the media items shown in list 50, an active preview is automatically played within a preview view 56 when the user maintains focus on the item, such as item 2 (54), for a predetermined idle time. The idle time may be set differently and may be based on many factors, such as the type of media items being navigated, the type of input 40 method used to navigate (i.e. keyboard, mouse, stylus, and the like) as well as the actions of a user. The idle time is set such that it may be determined that the user is not merely navigating from one media item to the next without desiring a preview of the media item. Generally, a user will pause briefly over a media item to indicate that a preview should be played. According to one embodiment, the idle time may be set from approximately 0.5 seconds to 1 second.

Media items 24 may be any type of media. For example, the media items may include audio, video, pictures, slide shows, podcasts, blogs, and the like. According to another embodiment, the media items may be any content that may have a preview associated with it. For example, the media items may be word processing documents where the preview provided is a portion of the document. The media items may also relate to products. For example, products on a web page may have active previews that are associated with them.

Active preview manager 26 may be implemented within media application 10 as shown in FIG. 2 or may be implemented externally from application 10 as shown in FIG. 1. In order to facilitate communication with the active preview manager 26, one or more callback routines, illustrated in FIG. 2 as callback code 32 may be implemented. Through the use of the callback code 32, the active preview manager 26 may query for additional information necessary to determine the media items that are being navigated. According to one embodiment, active preview manager 26 registers for focus change events such that it may determine when an active preview is to be shown on display 28.

Screen manager 30 may communicate with the active preview manager 26 to determine information related to media items that are displayed on a screen. The screen manager 30 may also provide to the active preview manager 26 the media item that currently has the focus from the screen. Screen manager 30 tracks the focus and provides the preview content to display 28 when an active preview is to be shown.

Although the media items being navigated are shown in list 50, the media items may be displayed in many different ways. For example, the media items may be displayed in a grid, a list, within folders, or in some other designated manner such that the media items may be navigated.

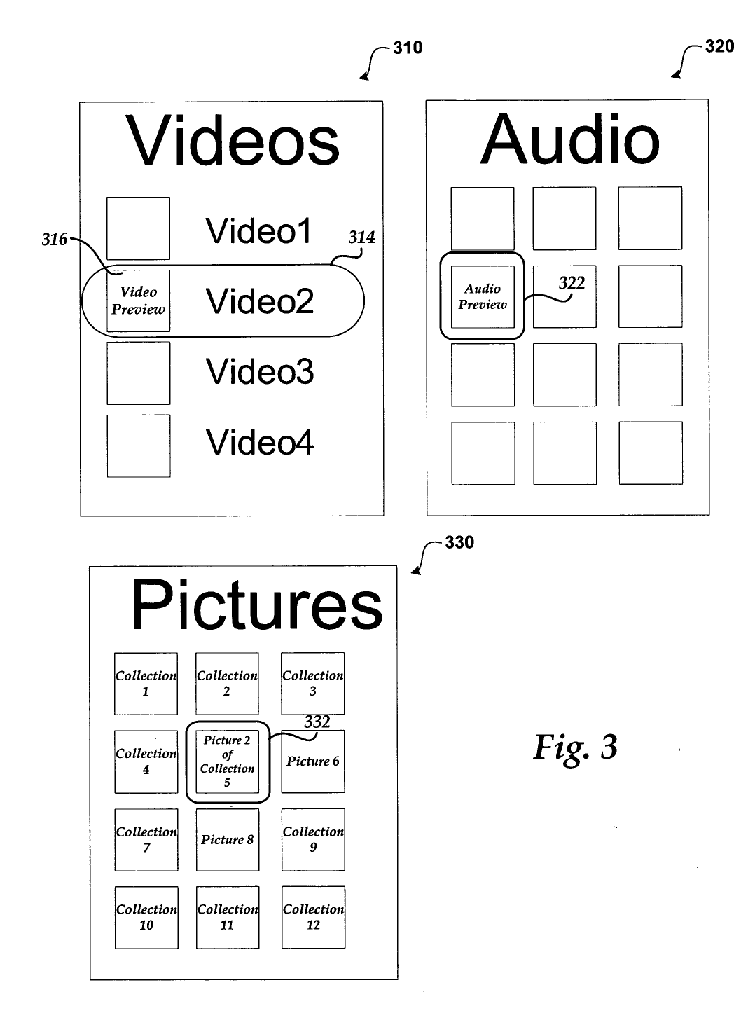

FIG. 3 shows navigation and active preview of exemplary media items. Display 310 shows a list of video media items. Display 320 shows a grid of audio media items and display 330 shows a grid of pictures being navigated. Although not shown, different types of media items may be included within a single display. For example, pictures, slide shows, videos, podcasts, and songs could be shown within the same display.

The active preview that is shown to a user may depend upon the type of media item that is selected. For example, when a video media item is selected, such as Video2 (314) from video list 310, a segment of that video may be shown within preview view 316. According to one embodiment, the preview view 316 is a thumbnail view. The preview video may include: a loop of a predetermined relevant segment of the video; a randomly selected segment of the video, a user's favorite or most watched segment, and the like. Alternatively, the looping preview video could be an edited video provided by an external source, such as a content provider, for preview purposes. For example, it could be a movie trailer, a commercial for the item, and the like.

When the media item is an audio media item as shown in display 320, the preview may be a portion of the audio, a picture, a video or some other preview. For example, when scrolling through a list of podcasts, if a user leaves focus on a podcast media item 322 for a predetermined idle time, a preview segment of the podcast could be played. This provides an easy way for a user to know what's in the podcast without having to jump to a text description located in another part of a user interface or listen to the actual podcast's beginning.

Display 330 shows navigating single pictures and collections of pictures. When the media item is a single picture, such as Picture 6, a segment of a picture may be shown as the preview. When the focus 332 is on a collection of media items then the preview may be a segment of each of the media items within the collection. For example, if the media item represents a group of pictures, then upon selection of the media item for the predetermined idle time, a slideshow of the pictures within the group may be shown as the preview.

The following table shows exemplary actions based on the type of media item. The previews, however, are not limited to the actions shown.

| | | Thumbnail review Methods upon |
|---|---|---|
| Media | Type | selection of item in list or grid |
| Video | On Demand | Show a predetermined segment of |
| | TV/Video | the video |
| | | Show a collection of predetermined |
| | | segments of the video |
| | | Show network's promotional preview |
| | | for the program. |
| | | Play the whole program. |
| | Broadcast TV (e.g. | Show network's promotional preview |
| | in a guide) | for the program. |
| | Recorded TV | Show a predetermined segment of |
| | | the video |
| | | Show a collection of predetermined |
| | | segments of the video |
| | | Show network's promotional preview |
| | | for the program. |
| | | Play the whole program. |
| | Short form video | Show a predetermined segment of |
| | content optimized | the video |
| | for mobile phones | Show a collection of predetermined |
| | | segments of the video |
| | | Show network's promotional preview |
| | | for the program. |
| | | Play the whole program. |
| | Movies | Show a predetermined segment of |
| | | the video |
| | | Show a collection of predetermined |
| | | segments of the video |
| | | Show studio's promotional preview |
| | | for the program. |
| | | Play the whole movie. |
| | Video Blogs | Show a predetermined segment of |
| | | the video |
| | | Show a collection of predetermined |
| | | segments of the video |
| | | Play the whole video. |
| | Video Podcasts | Show a predetermined segment of |
| | | the video |
| | | Show a collection of predetermined |
| | | segments of the video |
| | | Play the whole video |
| | Self authored video | Show a predetermined segment of |
| | | the video |
| | | Show a collection of predetermined |
| | | segments of the video |
| | | Play the whole video |
| Audio | Podcasts | Play a predetermined segment of the |
| | | audio file. |
| | | Play a collection of predetermined |
| | | segments of the audio file. |
| | | Play author's promotional audio |
| | | description of the item. |
| | Audio Books | Play the publisher's promotional |
| | | audio description of the item. |
| | On Demand Radio | Play the publisher's promotional |
| | programming | audio description of the item. |
| | Broadcast Radio | Play the publisher's promotional |
| | (e.g. in a guide) | audio description of the item. |
| | Music | Play a sample of the album or song. |
| Pictures | Individual | Pan and zoom through the picture |
| | picture | within the thumbnail area. |
| | Collection of | Play a quick slideshow of pictures in |
| | Pictures | the collection |
| | Photostories | Play a predetermined segment of the |
| | | photostory. |
| | | Play the whole photostory. |

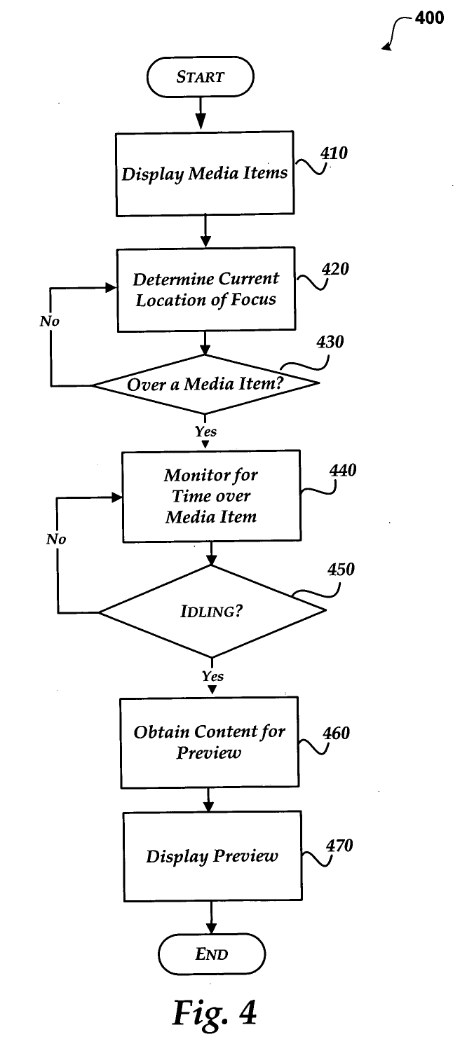

Referring now to FIG. 4, an illustrative process for actively previewing media items will be described. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments of the described herein are referred to variously as operations, structural devices, acts or modules. These operations, structural devices, acts and modules may be implemented in software, in firmware, in special purpose digital logic, and any combination thereof.

FIG. 4 shows a process 400 for providing an active preview for media items during navigation. After a start operation, the process moves to operation 410, where media items are displayed. As discussed above, the media items may be displayed in a number of different ways, such as in a list or a grid. The media items may also be displayed on a web page. For example, the media items may be products that are shown on a web page.

Moving to operation 420, a current location of the system focus is obtained. The current system focus is obtained to determine whether a user is over a media item during navigation.

Flowing to decision operation 430, a determination is made as to whether the user has navigated over a media item or a collection of media items. When the focus indicates that the user is not over a media item, the process returns to operation 420. When the focus indicates that the user has navigated over a media item, the process moves to operation 440.

At operation 440, the time the focus is maintained over the media item is measured. The process then flows to decision operation 450, where a determination is made as to whether the user is idling over the media item. In other words, is the user merely navigating past the media item or has the user paused over the media item. When the user is not idling over the media item, the process returns to operation 440. When the user is idling over the media item, the process transitions to operation 460 where content is obtained for the preview. The content may be any content that provides a preview that relates to the media item.

The process then flows to operation 470, where the preview is displayed. The preview may be displayed in many different screen locations. For example, the preview could be played: adjacent to the media item; above or below the media item if displayed semi-opaque; or in some predetermined area of the screen. According to one embodiment, the preview is displayed for as long as the user maintains focus over the media item. According to another embodiment, the preview is played for a predetermined time. The process then moves to an end operation and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for previewing media items, comprising:
displaying media items that may be navigated and selected;
navigating to a media item;
determining when a focus is maintained on the media item for a predetermined idle time; and
automatically playing a preview that is associated with the media item within a preview area.

2. The computer-implemented method of claim 1, wherein the media items include at least one of: a video media item; an audio media item; and a picture media item.

3. The computer-implemented method of claim 1, wherein automatically playing the preview that is associated with the media item within the preview area comprises playing a segment of the media item within at least one of: a thumbnail that is adjacent to a displayed name of the media item; a predetermined thumbnail area; and
a semi-opaque thumbnail.

4. The computer-implemented method of claim 3, further comprising automatically generating the segment from the media item that starts after a beginning of the media item.

5. The computer-implemented method of claim 3, further comprising generating the segment based on a received input indicating at least one of a starting position and an ending position for the segment.

6. The computer-implemented method of claim 1, wherein automatically playing the preview comprises automatically playing the preview that is based on a collection of media items.

7. The computer-implemented method of claim 6, wherein automatically playing the preview that is based on the collection of media items comprises previewing more than one of the media items that is contained within the collection.

8. The computer-implemented method of claim 2, further comprising stopping the preview when the media item loses focus.

9. The computer-implemented method of claim 8, wherein the idle time is determined based on an average navigation time from a first media item to a second media item.

10. A computer-readable medium having computer executable instructions for previewing media items, the instructions comprising:
navigating to a media item;
determining a time a focus is maintained on the media item;
automatically playing a preview for the media item when the time the focus is maintained on the media item exceeds an idle time; and
automatically stopping the preview.

11. The computer-readable medium of claim 10, wherein the media items include at least one of: a video media item; an audio media item; and a picture media item.

12. The computer-readable medium of claim 11, wherein automatically playing the preview for the media item comprises displaying at least one of: a predetermined segment of the media item; a collection of predetermined segments of the media item; a promotional preview for the media item; the entire media item; a sample of the media item; a pan and zoom of the media item; and a slideshow of the media item.

13. The computer-readable medium of claim 12, wherein the media item may include a collection of media items.

14. The computer-readable medium of claim 12, further comprising generating the segment based on an input that indicates a starting position and an ending position for the segment.

15. The computer-readable medium of claim 12, wherein automatically stopping the preview comprises automatically stopping the preview when the media item loses focus.

16. The computer-readable medium of claim 12, wherein the idle time is determined based on an average navigation time from a first media item to a second media item.

17. A system for previewing media items being navigated, comprising:
a display component that is configured to display a list of media items; wherein the media items include video media items; audio media items and picture media items;
an input component that is configured to receive input that is used to move a focus;
an active preview manager that is coupled to the display and the input component and that is configured to:
determine when the focus moves to a media item; wherein the media item may include a collection of media items;
determine when the focus is maintained for a predetermined time over the media item;
play a preview for the media item on the display within a thumbnail; and
stop the preview when the focus moves off of the media item.

18. The system of claim 17, wherein the preview for the media item comprises at least one of: a predetermined segment of the media item; a collection of predetermined segments of the media item; a promotional preview for the media item; the entire media item; a sample of the media item; a pan and zoom of the media item; and a slideshow of the media item.

19. The system of claim 18, further comprising a second display that is configured to display the preview.

20. The system of claim 18, wherein the idle time is set between approximately 400 ms and five seconds.
